(19) United States
(12) Patent Application Publication
(10) Pub. No.: US 2008/0122358 A1
(43) Pub. Date: May 29, 2008

(54) Plasma display panel

(76) Inventors: Jae-Ik Kwon, Suwon-si (KR); Won-Ju Yi, Suwon-si (KR); Kyoung-Doo Kang, Suwon-si (KR); Seok-Gyun Woo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/812,556

(22) Filed: Jun. 20, 2007

(30) Foreign Application Priority Data
Jun. 23, 2006 (KR) 10-2006-0057085

(51) Int. Cl. H01J 17/49

(52) U.S. Cl. 313/583

(57) ABSTRACT

Example embodiments relate to a plasma display panel including a first flexible substrate and a second flexible substrate opposing each other, a flexible electrode sheet having a plurality of electrodes to define a plurality of discharge spaces, the flexible electrode sheet may be between the first flexible substrate and the second flexible substrate, an exhaustion hole engaged with the second flexible substrate and may connect the discharge spaces to an outside, and a supporting unit installed between the first flexible substrate and the second flexible substrate adjacent to the exhaustion hole may be mounted, so as to connect the discharge spaces to the exhaustion hole.

### BACKGROUND OF THE INVENTION

1. Field of the Invention

Example embodiments relate to a plasma display panel (PDP) including a flexible substrate.

2. Description of the Related Art

As the amount of information has been exploding due to the recent development of communications techniques and wide-spread use of the Internet, displays in which a user may obtain information anytime and anywhere may be needed. In order to provide a display that may not be restricted by space, for example, display apparatuses should be freely installed in various places.

Conventional PDPs may include a substrate formed of an inflexible material, e.g., a glass material, which may have disadvantages of being heavy, thick and rigid (low flexibility). This may result in PDPs having limited field of use. Recently, in order to solve these problems, PDPs using a substrate formed of a flexible material has been developed.

PDPs may be flat display devices which may generate an image using a gas discharge technique. The gases filled in a plurality of discharge spaces formed between a pair of opposed substrates may be discharged so that ultraviolet (UV) light may be generated, and in response to the UV light, phosphors within the discharge spaces may emit visible light so that images may be displayed. Accordingly, an approach for exhausting gases in the discharge spaces using flexible substrates is needed.

A conventional PDP having the flexible substrates may be disposed to oppose each other, and a flexible electrode sheet may be placed between the substrates. The substrates may be sealed by a sealing member to perform an exhaustion process to exhaust impure gases inside the PDP to the outside, and may perform a sealing process to fill a discharge gas in the PDP.

During the exhaustion process, air inside the PDP may be exhausted to the outside through an exhaustion pipe which may be connected to one of the substrates. Thus, a low pressure may be formed inside the PDP, e.g., the PDP may be in a vacuum state. However, using flexible substrates may require the substrates to be attached to an inside of the PDP, e.g., attached to the flexible electrode sheet. Thus, the exhaustion process may not be smoothly performed. In other words, the flexible substrates may be pressed toward the inside of the PDP due to the pressure of the air. Because the flexible substrates attached to the electrode sheet may prevent the flow of the air from being exhausted to the outside, this may result in the exhaustion process from not being easily performed.

### SUMMARY OF THE INVENTION

Example embodiments are therefore directed to a plasma display panel (PDP), which substantially overcomes one or more of the problems due to the limitations and disadvantages of the related art.

It is therefore a feature of an example embodiment to provide a plasma display panel (PDP) with a flexible substrate in which an exhaustion process may be easily performed.

It is therefore another feature of an example embodiment to provide flexible substrates that may not be attached to each other during an exhaustion process.

It is therefore another feature of an example embodiment to provide a PDP having a supporting unit disposed between a first flexible substrate and a second flexible substrate.

At least one of the above and other features of example embodiments may be to provide a plasma display panel including a first flexible substrate and a second flexible substrate opposing each other, a flexible electrode sheet having a plurality of electrodes to define a plurality of discharge spaces, the flexible electrode sheet may be between the first flexible substrate and the second flexible substrate, an exhaustion hole engaged with the second flexible substrate and may connect the discharge spaces to an outside, and a supporting unit installed between the first flexible substrate and the second flexible substrate adjacent to the exhaustion hole may be mounted, so as to connect the discharge spaces to the exhaustion hole.

The first flexible substrate, the second flexible substrate and the flexible electrode sheet may be formed by at least one of a PES resin and a polyimide. Further, the first flexible substrate, the second flexible substrate and the flexible electrode sheet may be formed by a material including an organic material.

The supporting unit may further include a first block installed between the first flexible substrate and the flexible electrode sheet, and a second block installed between the second flexible substrate and the flexible electrode sheet. The second block may include an exhaustion path connected to the exhaustion hole of the second flexible substrate, and a connection path opened toward a space between the first flexible substrate and the second flexible substrate and connected to the exhaustion path.

The supporting unit may surround at least a portion of the exhaustion hole of the second flexible substrate, and may support the first flexible substrate and the second flexible substrate. Further, the supporting unit may surround an entire circumference of the exhaustion hole of the second flexible substrate.

The supporting unit may include a first block disposed between the first flexible substrate and the flexible electrode sheet, and a second block disposed to surround a portion of the exhaustion hole between the second flexible substrate and the flexible electrode sheet.

The second block may include an exhaustion path connected to an exhaustion hole of the second flexible substrate, and a connection path connected to the exhaustion path.

The first block may have a height that may correspond to a distance between the first flexible substrate and the flexible electrode sheet, and the second block may have a height that may correspond to a distance between the second flexible substrate and the flexible electrode sheet.

The second block may be composed of a single block, or the second block may be composed of at least two blocks.

The first electrodes may be formed on a first surface of the flexible electrode sheet, and the second electrodes may be formed on a second surface of the flexible electrode sheet. The plurality of electrodes may include discharge portions and connections portions connecting the discharge portions. The discharge space may have a circular ring shape, and the discharge portions may surround a circumference of the discharge space.

The plurality of electrodes may include a plating seal layer formed on the flexible electrode sheet, and a plating layer plated on the plating seed layer. The plating seed layer and the plating layer may be non-electrolytic. The plating seed layer and the plating layer may be formed by at least one of a PES resin and a polyimide.

At least one of the above and other features of example embodiments may be to provide a method of manufacturing a plasma display panel. The display panel may include a first flexible substrate and a second flexible substrate opposing each other, and a flexible electrode sheet having a plurality of electrodes to define a plurality of discharge spaces. The flexible electrode sheet being between the first flexible substrate and the second flexible substrate. The method may include forming an exhaustion hole on the second flexible substrate, installing a supporting unit between the first flexible substrate and the second flexible substrate adjacent to the exhaustion hole so as connect the discharge spaces to the exhaustion hole, and exhausting a gas in the discharge spaces to an outside.

### BRIEF DESCRIPTION OF THE DRAWINGS

The above and other features and advantages of the present invention will become more apparent to those of ordinary skill in the art by describing in detail example embodiments thereof with reference to the attached drawings, in which:

FIG. 1 illustrates an exploded perspective view of a PDP according to an example embodiment;

FIG. 2 illustrates a side cross-sectional view of the PDP illustrated in FIG. 1;

FIG. 3 illustrates an exploded perspective view of a PDP according to another example embodiment;

FIG. 4 illustrates a side cross-sectional view of a PDP according to another example embodiment; and

FIG. 5 illustrates an exploded perspective view of a portion of the PDP illustrated in FIG. 4.

### DETAILED DESCRIPTION OF THE INVENTION

Korean Patent Application No. 10-2006-0057085, filed on Jun. 23, 2006, in the Korean Intellectual Property Office, and entitled: “Plasma Display Panel,” is incorporated by reference herein in its entirety.

Example embodiments will now be described more fully hereinafter with reference to the accompanying drawings. Example embodiments may, however, be embodied in different forms and should not be construed as limited to the embodiments set forth herein. Rather, these example embodiments are provided so that this disclosure will be thorough and complete, and will fully convey the scope of the invention to those skilled in the art.

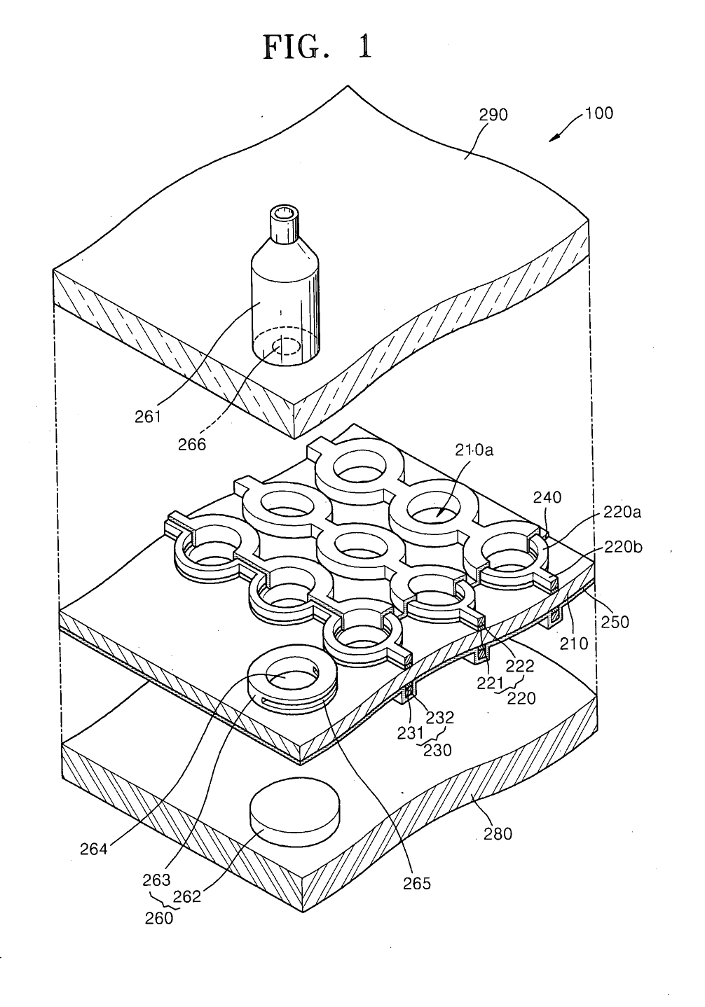

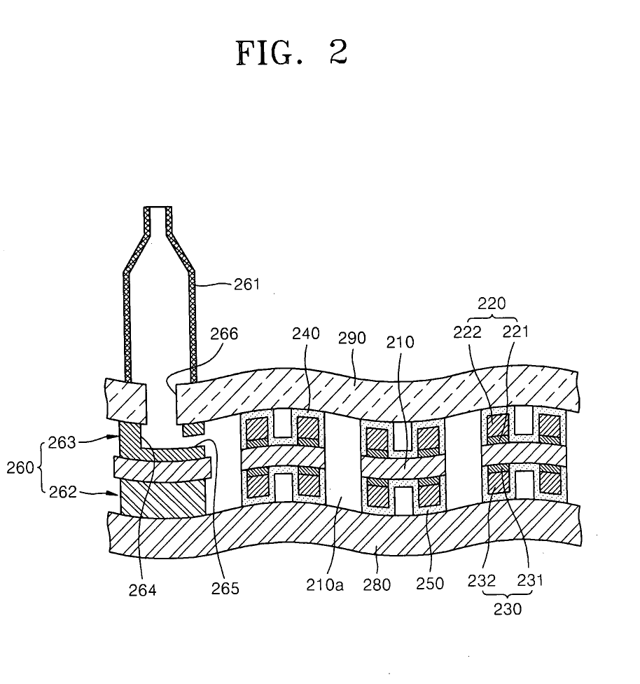

FIG. 1 illustrates an exploded perspective view of a PDP according to an example embodiment; and FIG. 2 illustrates a side cross-sectional view of the PDP illustrated in FIG. 1.

A PDP 100 may include a first substrate 280, a second substrate 290, an electrode sheet 210, an exhaustion pipe 261, and a supporting unit 260. It should be appreciated that the PDP 100 may include other elements and/or devices. The first substrate 280 and the second substrate 290 may be flat plates possessing flexible properties. The first and second substrates 280 and 290 may be formed of a material including at least one of polyether sulfone (PES) resin and polyimide and/or a material including an organic material. It should be appreciated that the first substrate 280 and the second substrate 290 may be formed from other materials, and in various other combinations. The first substrate 280 and the second substrate 290 may be disposed to oppose each other by a distance.

The electrode sheet 210 may be disposed between the first substrate 280 and the second substrate 290, and may form a plurality of discharge spaces 210a. The electrode sheet 210 may possess flexible properties. The electrode sheet 210 may be formed of a material including at least one of PES resin and polyimide and/or a material including an organic material. It should be appreciated that the electrode sheet 210 may be formed from other materials, and in various other combinations.

Due to the flexibility of the first and second substrates 280 and 290, the PDP 100 may be applied to a variety of fields, as compared to a conventional PDP, which may include an inflexible substrate formed of a material, e.g., rigid glass.

The electrode sheet 210 may include a plurality of electrodes 220 and 230. Electrodes 220 and 230 may be formed on a surface of the electrode sheet 210. However, it should be appreciated that electrodes 220 and 230 may also be buried inside of the electrode sheet 210. In an example embodiment, electrodes 220 and 320 may extend in the surface of the electrode sheet 210, and may cause a plasma discharge by an electrical signal supplied from an outside.

The plurality of discharge spaces 210a may be formed inside of the electrode sheet 210. In an example embodiment, an opening may be perforated into a surface toward the second substrate 290 from a surface toward the first substrate 280 of the electrode sheet 210 so as to form the discharge space 210a. When the first substrate 280 and the second substrate 290 are assembled with the electrode sheet 210 placed between the first and second substrates 280, a gas may be filled in the discharge space 210a. The discharge space 210a may have various shapes including, for example, but not limited to, a polygonal shape, e.g., a rectangular shape, an elliptical shape or a circular shape. One skilled in the art should appreciate that other shapes may be employed.

Further, it should be appreciated that phosphor layers (not shown) may be formed in the discharge space 210a.

The electrode sheet 210 and the first and second substrates 280 and 290 should be sealed so that a gas may be filled in the discharge space 210a. The electrode sheet 210 and the first and second substrates 280 and 290 may be sealed by a sealing member (not shown) and/or a method including thermal compression. It should be appreciated that other methods may be employed to seal the electrode sheet 210 and the first and second substrates 280 and 290.

Electrodes 220 and 230 may surround the discharge space 210a formed inside the electrode sheet 210, and may extend along the surface of the electrode sheet 210. In an example embodiment, electrodes 220 may be formed on one surface of the electrode sheet 210 and electrodes 230 may be formed on the opposite surface of the electrode sheet 210. Electrodes 220 may extend across the electrode sheet 210, and may be disposed to be substantially parallel to each other.

Electrodes 230 may extend to be parallel to electrode 220. It should be appreciated that electrodes 220 and 230 may be configured in other arrangements.

Further, electrodes 220 and 230 may be spaced apart from each other by a gap (e.g., distance, space, break, opening, etc.) so that the discharge space 210a, in which gas may be filled, may be placed between electrodes 220 and 230. Thus, if currents are supplied to electrodes 220 and 230, a discharge may occur in the discharge space 210a.

Electrodes 220 may include discharge portions 220a which may contribute to a discharge, and connection portions 220b connecting the discharge portions 220a. The discharge portions 220a may be shaped so as to completely surround a circumference of the discharge space 210a. In an example embodiment, the discharge portions 220a may be a circular ring-shape, and may completely surround the discharge space 210a. In alternative example embodiments, it should be appreciated that the discharge portions 220a may surround only a portion of the circumference of the discharge space 210a and/or may have another shape other than a circular shape, e.g., the discharge portions 220a may be semi-circular and may surround a portion of the discharge space 210a, or may have other shapes including a polygonal, e.g., a rectangular shape or an elliptical shape.

In an example embodiment, electrodes 220 and 230 may extend to be parallel to each other, and address electrodes (not shown) may be installed on the first substrate 280 and/or the second substrate 290, so as to select the discharge space 210a in which a sustain discharge may occur. The address electrodes may extend in a direction which may cross in a direction of electrodes 220 and 230. It should be appreciated that electrodes 220 and 230 and/or address electrodes may be configured in other arrangements.

Electrodes 220 may be formed of a single layer having a conductive material or electrodes 220 may be multi-layered. Electrodes 220 may include a plating seed layer 221 formed on the electrode sheet 210, and a plating layer 222 plated on the plating seed layer 221. An insulating layer 240 may be formed on the surfaces of electrodes 220 and the electrode sheet 210.

The plating seed layer 221 may be a layer which may serve as a base for forming the plating layer 222 on the electrode sheet 210. The plating sheet layer 221 may be formed of a material, which may be flexible, such as, but not limited to, a PES resin and/or a polyimide, and which may be easily deposited on the electrode sheet 210.

Electrodes 230 may include a plating seed layer 231 and a plating layer 232, similar to electrodes 220. An insulating layer 250 may be formed on the surfaces of electrodes 230 and the electrode sheet 210.

The plating layers 222 and 232 may perform the function of an electrode for transmitting an electrical signal, and thus, provide electrical conductivity. The plating layers 222 and 232 may be formed of material which may be easily plated on the plating seed layers 221 and 231.

By constituting electrodes 220 and 230 with the plating seed layers 221 and 231 and the plating layers 222 and 232 plated on the plating seed layers 221 and 231, electrodes 220 and 230 may be easily formed on the electrode sheet 210.

The plating seed layers 221 and 231 and the plating layers 222 and 232 of electrodes 220 and 230 may be non-electrolytic seed layers and non-electrolytic plating layers. By using the non-electrolytic seed layers and the non-electrolytic plating layers, electrodes 220 and 230 may be more easily formed on the surface of the electrode sheet 210 as compared to when an electrolytic plating seed layer and an electrolytic plating layer are used.

The insulating layers 240 and 250 may be formed on the plurality of electrodes 220 and 230. The insulating layers 240 and 250 may be formed to cover the entire (or substantially entire) surface of the electrode sheet 210. It should be appreciated that the insulating layers 240 and 250 may be formed on a portion of the electrode sheet 210 so as to cover only a portion of the plurality of electrodes 220 and 230.

The insulating layers 240 and 250 may be formed of various materials, but it should be appreciated that the insulating layers 240 and 250 may be formed of the same flexible material which is used in forming the electrode sheet 210. For example, the insulating layers 240 and 250 may include a PES resin and/or a polyimide. If the insulating layers 240 and 250 are formed of a flexible material, the flexibility of the electrode sheet 210 may be improved. Further, if the material of the insulating layers 240 and 250 is the same as the material for the electrode sheet 210, the degrees of flexibility of the insulating layers 240 and 250 and the electrode sheet 210 may be similar. As a result, cracks may be prevented and/or reduced at locations between the insulating layers 240 and 250 and the electrode sheet 210.

An exhaustion pipe 261 for performing an exhaustion process may be installed in the second substrate 290. The exhaustion pipe 261 may be engaged on one side of the second substrate 290, and may connect the inside space of the PDP 100 to the outside. Because the exhaustion pipe 261 may be combined with an exhaustion hole 266 formed in the second substrate 290, the exhaustion pipe 261 may connect the discharge spaces 210a inside the PDP to the outside.

A supporting unit 260 for supporting the first substrate 280 and the second substrate 290 may be installed between the first substrate 280 and the second substrate 290 in a position where the exhaustion pipe 261 may be installed. The supporting unit 260 may include a first block 262 installed between the first substrate 280 and the electrode sheet 210, and a second block 263 installed between the second substrate 290 and the electrode sheet 210. The first block 262 may support the first substrate 280 and the electrode sheet 210 at a circumference of the exhaustion pipe 261, and the second block 263 may support the second substrate 290 and the electrode sheet 210 at a circumference of the exhaustion pipe 261.

The second block 263 may have a height corresponding to a distance between the second substrate 290 and the electrode sheet 210, and may include an exhaustion path 264 and a connection path 265, which may be formed inside the second block 263. One skilled in the art should appreciate that other heights may be employed depending on the distance between the second substrate 290 and the electrode sheet 210. Because the exhaustion path 264 may be a through hole formed on a surface of the second block 263, which may contact the second substrate 290, the exhaustion path 264 may be connected to the exhaustion hole 266. The connection path 265 may be an opening formed on the surface of the second block 263 and may be connected to the exhaustion path 264. Thus, an internal space of the PDP 100 may be connected to the outside via the connection path 265, the exhaustion path 264 of the second block 263, the exhaustion hole 266, and the exhaustion pipe 261 in sequence.

When the first substrate 280, the electrode sheet 210 and the second substrate 290 are assembled together and sealed, air and impurities existing inside the PDP 100 may be exhausted to the outside through the exhaustion pipe 261. After the exhaustion process is completed, a discharge gas may be injected into the inside of the PDP 100 through the exhaustion pipe 261.

Moreover, the air inside the PDP may be exhausted to the outside via the connection path 265, the exhaustion path 264 of the second block 263 and the exhaustion pipe 261 in sequence. As the air may be exhausted to the outside, a low pressure may be formed inside the PDP 100, e.g., the PDP 100 may be in a vacuum state.

Due to the first substrate 280, the second substrate 290 and the electrode sheet 210 being supported by the first block 262 and the second block 263 in a position where the exhaustion pipe 261 may be mounted, there may not be any need to bend or closely attach the first substrate 280 and/or the second substrate 290 to each other. As a result, the air passing through the exhaustion hole 266 may be maintained in a stable flow state, and thus, the exhaustion process may be smoothly performed. After the completion of the exhaustion process, a discharge gas may be injected into the inside of the PDP through the exhaustion pipe 261. Then, after the discharge gas fills the PDP 100, the exhaustion pipe 261 may be removed, and the exhaustion hole 266 may be sealed.

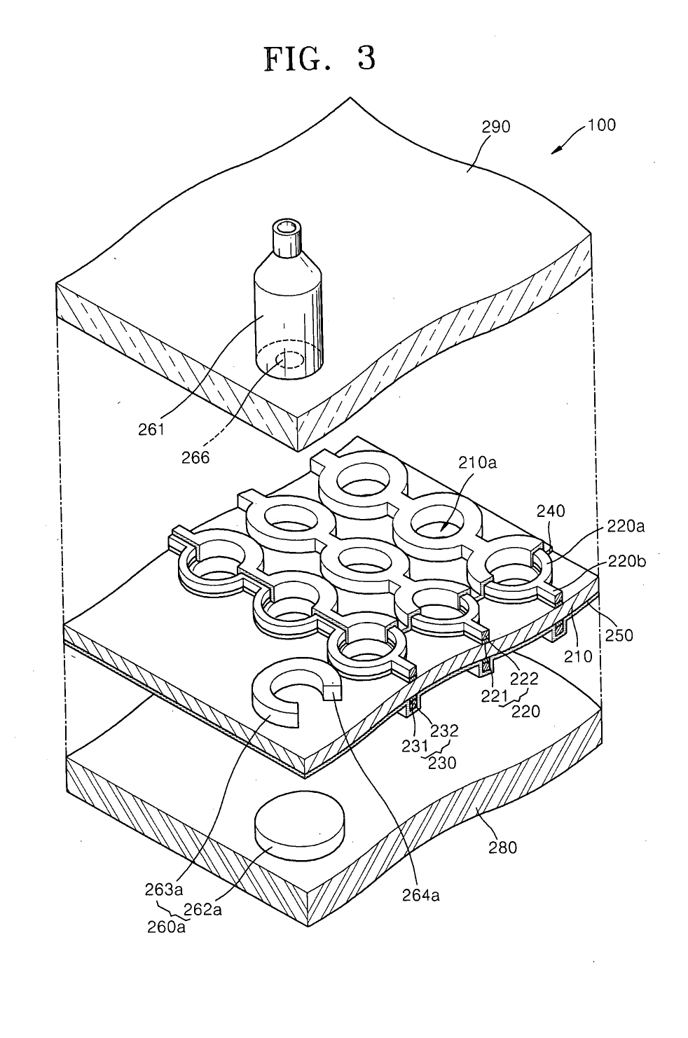

FIG. 3 is an exploded perspective view of a PDP according to another example embodiment.

The structure shown in FIG. 3 may be similar to FIG. 1, except for a supporting unit 260a. Specifically, the supporting unit 260a may have a different shape than the supporting unit 260 as illustrated in FIG. 1. Although the shape of the supporting unit 260a may be modified, the supporting unit 260a may support the first substrate 280 and the second substrate 290, and may perform the same function of connecting a space between a first substrate 280 and a second substrate 290 to a exhaustion pipe 261.

The supporting unit 260a may be disposed between the first substrate 280 and the second substrate 290 to surround at least a portion of an exhaustion hole 266 of the second substrate 290. The supporting unit 260a may include a first block 262a and a second block 263a. The first block 262a may have the similar shape as that shown in FIG. 2. It should be appreciated that the first block 262a may be configured into other shapes. The first block 262a may be disposed between the first substrate 280 and the electrode sheet 210, and may support the first substrate 280 and the electrode sheet 210. The second block 263a may be disposed between the second substrate 290 and the electrode sheet 210 to surround a portion of the exhaustion hole 266, and may support the second substrate 290 and the electrode sheet 210.

An opened portion 264a may be formed with the second block 263a. The opened portion 264a may be in the space between the first substrate 280 and the second substrate 290, and may be connected to the exhaustion hole 265. The internal space of the PDP 100 may be connected to an outside through the opened portion 264a, the exhaustion hole 266 of the second block 263a, and the exhaustion pipe 261. Thus, when the exhaustion process is performed, the air inside the PDP 100 may be exhausted to the outside via the above path.

After the first substrate 280, the second substrate 290, and the electrode sheet 210 are assembled together and sealed, the sealing process may be performed.

Because the first block 262a may support the first substrate 280 and the electrode sheet 210, and the second block 263a may support the second substrate 290 and the electrode sheet 210, the first and second substrates 280 and 290 do not need to be bent so as to be closely attached to each other. As a result, the exhaustion process may be steadily performed (even if the inside of the PDP 100 may be in a vacuum state due to the exhaustion process). After the exhaustion process, the exhaustion pipe 261 may be removed, and the exhaustion hole 266 may be sealed.

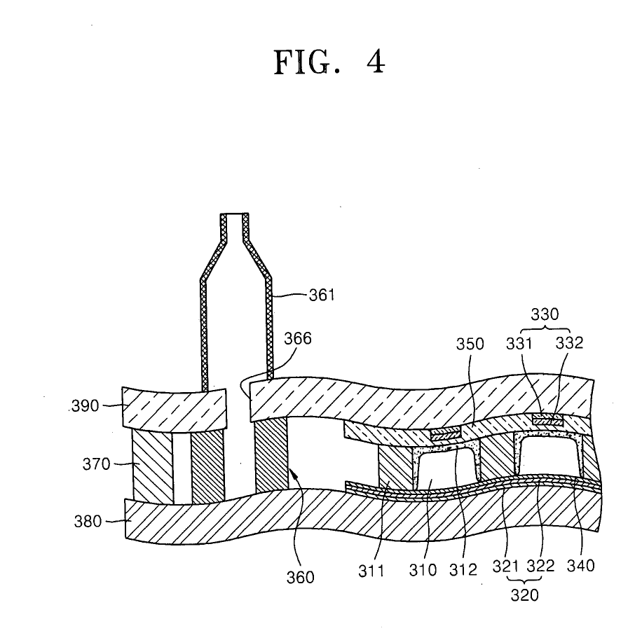

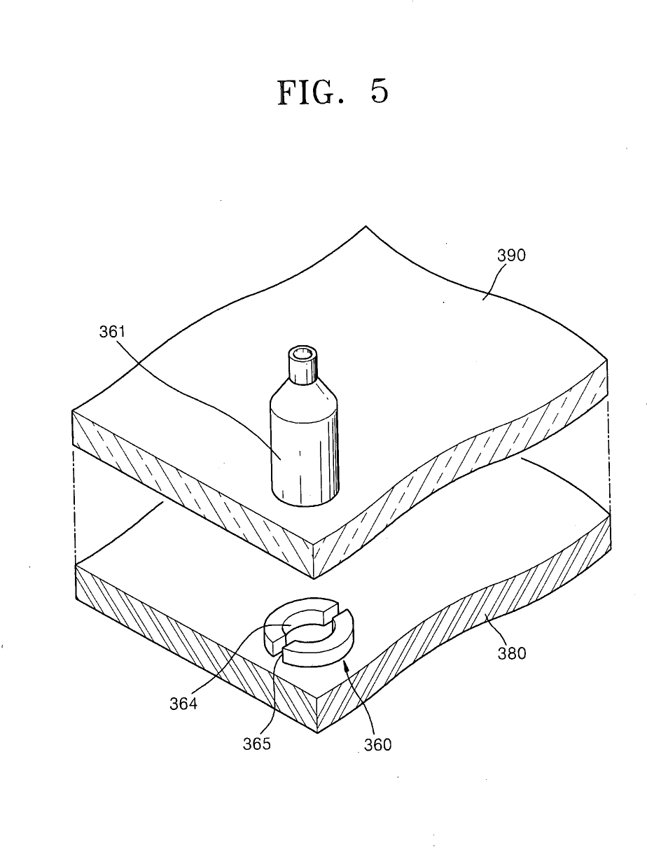

FIG. 4 illustrates a side cross-sectional view of a PDP according to another example embodiment, and FIG. 5 illustrates an exploded perspective view of a portion of the PDP illustrated in FIG. 4.

Referring to FIG. 4, the PDP 100 may include a first substrate 380, a second substrate 390, an exhaustion pipe 361, and a supporting unit 360. It should be appreciated that other elements and/or devices may be included to form the PDP 100.

The first substrate 380 and the second substrate 390 may be disposed by a distance to form a plurality of discharge spaces 310 in which a gas may be filled. The first substrate 380 and the second substrate 390 may be flat plates having flexible properties, and may be formed of at least one of a PES resin and a polyimide and/or a material including an organic material. It should be appreciated that other materials may be employed to form the first substrate 380 and the second substrate 390.

A plurality of electrodes 320 and 330 may be disposed on the surfaces of the first and second substrates 380 and 390. Electrodes 320 and 330 may be disposed in a stripe-like manner, as similar shown in FIGS. 1 and 3. It should be appreciated that electrodes 320 and 330 may also be disposed in various configurations, including a matrix. Electrodes 320 and 330 formed on the first and second substrates 380 and 390 may be formed of a single layer having a conductive material or electrodes 320 and 330 may be multi-layered.

Electrodes 320 may be formed on the first substrate 380, and may serve as sustain electrodes which may be display electrodes and scan electrodes, for example. Electrodes 330 may be formed on the second substrate 390. Electrodes 330 may be address electrodes, for example, formed in a direction which may cross electrodes 320.

Electrodes 320 formed on the first substrate 380 may include a plating seed layer 321 and a plating layer 322 with a conductive material plated on the plating seed layer 321. An insulating layer 340 may be formed on the surfaces of electrodes 320 and the first substrate 380. Electrodes 330 may also include a plating seed layer 331 and a plating layer 332, and an insulating layer 350 may be formed on the surfaces of electrodes 330 and the second substrate 390.

The plating seed layers 321 and 331 may be layers which may serve as a base for forming the conductive layers 322 and 332 on the first and second substrates 380 and 390. The plating seed layers 321 and 331 may be formed of material, such as, but not limited to, a PES resin and/or a polyimide so as to be easily deposited on the first and second substrates 380 and 390.

The plating layers 322 and 332 may perform the function of an electrode for transmitting an electrical signal, and thus, provide electrical conductivity. The plating layers 322 and 332 may be formed of material which may be easily plated on the plating seed layers 321 and 331.

The insulating layers 340 and 350 formed on electrodes 320 and 330 may be formed of a flexible material similar to the material used in forming the first and second substrates 380 and 390. For example, the insulating layers 340 and 350 may be made from a PES resin and/or a polyimide.

A plurality of barrier ribs 311 may be formed between the first substrate 380 and the second substrate 390 so as to form a plurality of discharge spaces 310. Phosphor layers 312 may be formed on surfaces of the discharge spaces 310 and a gas may be filled in the discharge spaces 310. The barrier ribs 311 may be in a stripe-like manner extending in one direction or a matrix. It should be appreciated that other configurations may be employed.

An exhaustion pipe 361 used in an exhaustion process may be engaged with the second substrate 390. Because the exhaustion pipe 361 may be engaged with the second substrate 390, which may be connected to an exhaustion hole 366 formed in the second substrate 390, the exhaustion pipe 361 may connect the discharge space 310 inside the PDP to the outside.

The first substrate 380 and the second substrate 390 may be sealed by a sealing member 370. The sealing member 370 may seal the space between the first substrate 380 and the second substrate 390 while surrounding edges of the first substrate 380 and the second substrate 390.

A supporting unit 360 for supporting the first substrate 380 and the second substrate 390 may be installed between the first substrate 380 and the second substrate 390 in a position where the exhaustion pipe 361 may be installed. Further, the supporting unit 360 may connect the internal space of the PDP 100 to the outside.

The supporting unit 360 may include an exhaustion path 364 connected to the exhaustion hole 366 of the second substrate 390, and a connection path 365 connected to the exhaustion path 364 and opened toward the space between the first substrate 380 and the second substrate 390. The supporting unit 360 may be fabricated of one block surrounding a circumference of the exhaustion hole 366 or may surround a portion of the exhaustion hole 366.

Referring to FIG. 5, the supporting unit 360 may include two blocks for surrounding a portion of the exhaustion hole 366. Because the two blocks may be disposed to oppose each other to form the exhaustion path 364 connected to the upper exhaustion hole 366 and disposed to be spaced apart from each other by a distance, the connection path 365 opened toward the space between the first substrate 380 and the second substrate 390 may be formed on a side surface of the supporting unit 360. Thus, the internal space of the PDP 100 may be connected to the outside via the connection path 365, the exhaustion path 364 of the supporting unit 360, the exhaustion hole 366, and the exhaustion pipe 361 in sequence. Further, once the exhaustion process is completed, a discharge gas may be injected into the inside of the PDP through the exhaustion pipe 361. Then, after the discharge gas fills the PDP 100, the exhaustion pipe 361 may be removed, and the exhaustion hole 366 may be sealed.

It should further be appreciated that the supporting unit 360 may be fabricated with more than two blocks to surround the exhaustion hole 366, e.g., four blocks.

If the first substrate 380 and second substrate 390 are assembled together and sealed, the air and impurities existing inside the PDP may be exhausted to the outside through the exhaustion pipe 361. After the exhaustion process is completed, a discharge gas may be injected into the inside of the PDP through the exhaustion pipe 361. Then after the discharge gas fills the PDP 100, the exhaustion pipe 361 may be removed, and the exhaustion hole 366 may be sealed.

The air inside the PDP 100 may be exhausted to the outside via the connection path 365, the exhaustion path 364 of the supporting unit 360, the exhaustion hole 366, and the exhaustion pipe 361 in sequence. As air may be exhausted to the outside, a low pressure may be formed inside the PDP 100, e.g., the PDP 100 may be in a vacuum state.

Because the first substrate 380 and the second substrate 390 may be supported by the supporting unit 360 in a position where the exhaustion pipe 361 may be mounted, the first substrate 380 or the second substrate 390 may not be bent so as to closely attach to each other. As a result, air passing through the exhaustion hole 366 and the exhaustion pipe 361 may be maintained in a steady flow state, and thus, the exhaustion process may be smoothly performed.

In accordance to example embodiments, a supporting unit disposed between a first substrate and a second substrate may be provided such that the first and second substrates may not be attached to each other during an exhaustion process.

The supporting unit may support the substrates and an electrode sheet, and may connect a plurality of discharge spaces to an exhaustion pipe so that an exhaustion process of the PDP with a flexible substrate may be easily performed.

In the figures, the dimensions of layers and regions may be exaggerated for clarity of illustration. It will also be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Further, it will be understood that when a layer is referred to as being “under” or “above” another layer, it can be directly under or directly above, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

It will also be understood that, although the terms “first” and “second,” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed above could be termed a second element, structure, component, region, layer or section without departing from the teachings of example embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or layers described as “below” or “beneath” other elements or layers would then be oriented “above” the other elements or layers. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to limit the example embodiments. As used herein, the singular forms “a,” “an” and “the” are intended to include the plural forms as well, unless the context clearly indicates otherwise.

Example embodiments are described herein with reference to cross-sectional illustrations that are schematic illustrations of idealized embodiments and/or intermediate structures. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a first flexible substrate and a second flexible substrate opposing each other;
a flexible electrode sheet including a plurality of electrodes to define a plurality of discharge spaces, the flexible electrode sheet being between the first flexible substrate and the second flexible substrate;
an exhaustion hole formed in the second flexible substrate and adapted to connect the discharge spaces to an outside; and
a supporting unit installed between the first flexible substrate and the second flexible substrate adjacent to the exhaustion hole, so as to connect the discharge spaces to the exhaustion hole.

2. The plasma display panel as claimed in claim 1, wherein the first flexible substrate, the second flexible substrate and the flexible electrode sheet are formed by at least one of a PES resin and a polyimide.

3. The plasma display panel as claimed in claim 2, wherein the first flexible substrate, the second flexible substrate and the flexible electrode sheet include a material having an organic material.

4. The plasma display panel as claimed in claim 1, wherein the supporting unit further comprising:
a first block installed between the first flexible substrate and the flexible electrode sheet; and
a second block installed between the second flexible substrate and the flexible electrode sheet.

5. The plasma display panel as claimed in claim 4, wherein the second block comprises an exhaustion path connected to the exhaustion hole, and a connection path opened toward a space between the first flexible substrate and the second flexible substrate and connected to the exhaustion path.

6. The plasma display panel as claimed in claim 1, wherein the supporting unit surrounds at least a portion of the exhaustion hole, and supports the first flexible substrate and the second flexible substrate.

7. The plasma display panel as claimed in claim 6, wherein the supporting unit surrounds an entire circumference of the exhaustion hole.

8. The plasma display panel as claimed in claim 6, wherein the supporting unit comprises a first block disposed between the first flexible substrate and the flexible electrode sheet, and a second block disposed to surround a portion of the exhaustion hole between the second flexible substrate and the flexible electrode sheet.

9. The plasma display panel as claimed in claim 4, wherein the second block comprises an exhaustion path connected to an exhaustion hole of the second flexible substrate, and a connection path opened toward a space between the first flexible substrate and the second flexible substrate and connected to the exhaustion path.

10. The plasma display panel as claimed in claim 4, wherein the first block has a height that corresponds to a distance between the first flexible substrate and the flexible electrode sheet, and the second block has a height that corresponds to a distance between the second flexible substrate and the flexible electrode sheet.

11. The plasma display panel as claimed in claim 4, wherein the second block is composed of a single block.

12. The plasma display panel as claimed in claim 4, wherein the second block is composed of at least two blocks.

13. The plasma display panel as claimed in claim 1, wherein the first electrodes are formed on a first surface of the flexible electrode sheet, and the second electrodes are formed on a second surface of the flexible electrode sheet.

14. A plasma display panel, comprising:
a first flexible substrate and a second flexible substrate opposing each other to define a plurality of discharge spaces between the first flexible substrate and the second flexible substrate;
an exhaustion hole formed in the second flexible substrate and adapted to connect the discharge spaces to an outside; and
a supporting unit installed between the first flexible substrate and the second flexible substrate adjacent to the exhaustion hole, so as to connect the discharge spaces to the exhaustion hole.

15. The plasma display panel as claimed in claim 14, wherein the supporting unit comprises an exhaustion path connected to the exhaustion hole, and a connection path opened toward a space between the first flexible substrate and the second flexible substrate and connected to the exhaustion path.

16. The plasma display panel as claimed in claim 14, wherein the supporting unit surrounds at least a portion of the exhaustion hole, and supports the first flexible substrate and the second flexible substrate.

17. A method of manufacturing a plasma display panel, the display panel includes a first flexible substrate and a second flexible substrate opposing each other, and a flexible electrode sheet having a plurality of electrodes to define a plurality of discharge spaces, the flexible electrode sheet being between the first flexible substrate and the second flexible substrate, the method comprising:
forming an exhaustion hole on the second flexible substrate;
installing a supporting unit between the first flexible substrate and the second flexible substrate adjacent to the exhaustion hole so as connect the discharge spaces to the exhaustion hole; and
exhausting a gas in the discharge spaces to an outside.

18. The method as claimed in claim 17, further comprising filing the discharge spaces with a discharge gas through the exhaustion hole.

19. The method as claimed in claim 18, further comprising sealing the exhaustion hole.

20. The method as claimed in claim 17, wherein the supporting unit further comprises:
a first block installed between the first flexible substrate and the flexible electrode sheet; and
a second block installed between the second flexible substrate and the flexible electrode sheet.

21. The method as claimed in claim 20, wherein the second block comprises an exhaustion path connected to the exhaustion hole, and a connection path opened toward a space between the first flexible substrate and the second flexible substrate and connected to the exhaustion path.

22. The method as claimed in claim 17, wherein the supporting unit surrounds at least a portion of the exhaustion hole, and supports the first flexible substrate and the second flexible substrate.

23. The method as claimed in claim 20, wherein the supporting unit surrounds an entire circumference of the exhaustion hole.
